(19) United States
(12) Patent Application Publication
(10) Pub. No.: US 2002/0105282 A1
(43) Pub. Date: Aug. 8, 2002

(54) TWIN-BULB CHRISTMAS LIGHT BULB STRING

(76) Inventor: Hung Huei Cheng, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/776,840

(22) Filed: Feb. 6, 2001

(51) Int. Cl. H05B 39/00

(52) U.S. Cl. 315/185 S; 315/312

(57) ABSTRACT

The present invention relates to a twin-bulb Christmas light bulb string of a curtain-type light bulb string. It mainly combines every two bulb-assemblies at a same level on the branch string to become a twin-bulb single body by a loop or the like for providing a special and different decorative effect. This obtains improvement and utility.

### BACKGROUND OF THE INVENTION

A conventional curtain-type decorative bulb string includes a main electrical wire with several parallel branch strings. The said branch string has an extended electrical wire being provided with several bulb assemblies in interval for lighting effect. Each bulb assembly is positioned singly and the lighting effect of this prior known curtain-type string would be not enough for decoration.

Accordingly, the primary object of the invention is to provide an improved curtain-type Christmas light bulb string with twin-bulb provided on the branch electrical wire to obtain a different decorative effect and to increase the utility. Now the features and advantages of the present invention will be described in detail with reference to the accompanying drawings.

### BRIEF DESCRIPTION OF ACCOMPANYING DRAWINGS

FIG. 1 is a plan view showing a twin-bulb Christmas light bulb string according to the present invention.

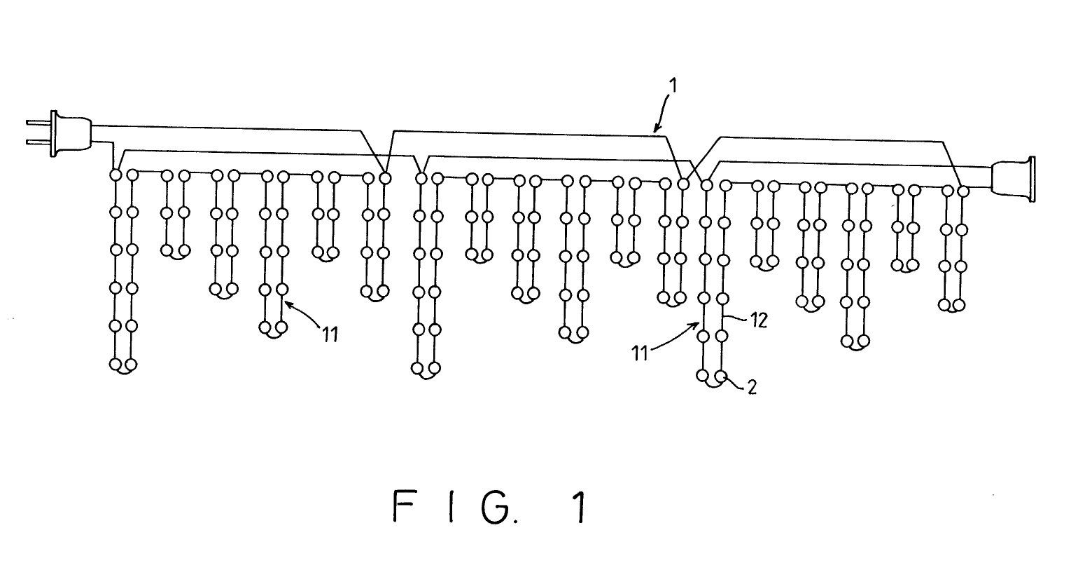

FIG. 2 is a perspective view showing parts of the twin-bulb on the branch electrical wire according to the present invention.

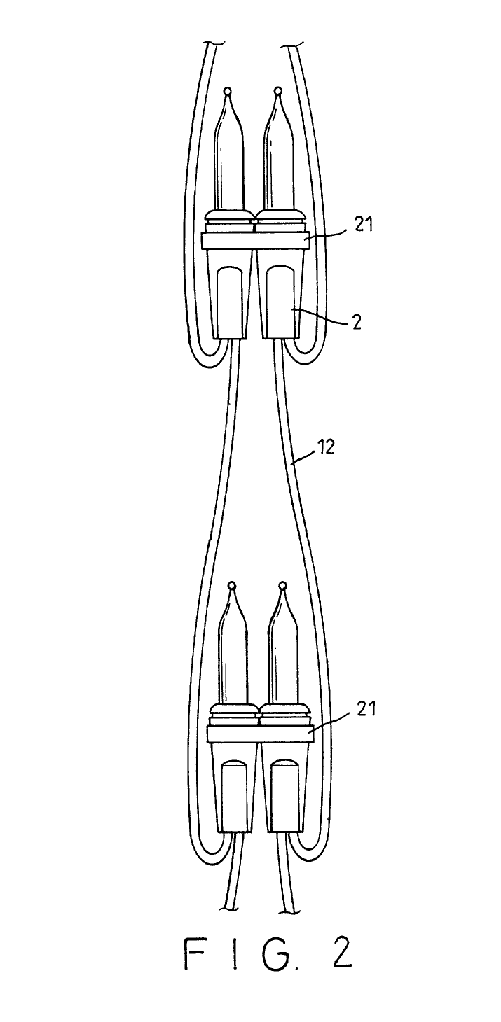

### DETAILED DESCRIPTION OF PREFERRED EMBODIMENTS

Referring to the affixed drawings, the present invention is to provide an improved curtain-type light bulb string, which includes a main electrical wire (1) with several parallel branch strings (11). Each branch string (11) has an extended electrical wire (12) with a plurality of bulb assembly (2) being positioned in interval. The characteristic of the present invention is that every two of the bulb assembly (2) at a same level on the branch string (11) can be combined by a loop (21) to become a twin-bulb structure as a single body while the branch string is equally folded. It is completed a curtain-type Christmas light bulb string with twin-bulb decoration.

After the above assembly, the twin-bulb structure on each branch string of the present invention will provide a better lighting effect. The structure of the twin-bulb also increases the lighting decoration and is absolutely novel. Thus it has excellent practical value in the field. Evidently the invention has the essence of a patent. We hereby apply for a patent grant.

Moreover, the above structure is only an exemplary according to the present invention. Any simple modification under the spirit of this invention, such as increasing the number of the combined bulbs or combining the bulbs by winding the electrical wire instead of using the loop, will be claimed in this application.

What is claimed is:

1. A twin-bulb Christmas light bulb string being a curtain-type light bulb string including a main electrical wire with several parallel branch strings, each of which has a plurality of bulb assembly positioned in interval; and the characteristic is that every two bulb assembly at a same level on the branch string being combined to become a single twin-bulb body by a loop while the branch string is equally folded.

2. The twin-bulb Christmas light bulb string as claimed in claim 1, wherein the number of the bulb assembly to be combined can be more than two.

3. A twin-bulb Christmas light bulb string having a main electrical wire with several parallel branch string being folded and winded to position two bulb assembly at a same level to become a twin-bulb structure.

4. The twin-bulb Christmas light bulb string as claimed in claim 3, wherein the number of the bulb assembly to be combined can be more than two.
